(19) United States
(12) Patent Application Publication
(10) Pub. No.: US 2019/0392420 A1
(43) Pub. Date: Dec. 26, 2019

(54) LOCATION-AWARE EVENT MONITORING

(71) Applicants: Anand Atreya, San Francisco, CA (US); Nicholas Hays, San Francisco, CA (US)

(72) Inventors: Anand Atreya, San Francisco, CA (US); Nicholas Hays, San Francisco, CA (US)

(21) Appl. No.: 16/419,326

(22) Filed: May 22, 2019

Related U.S. Application Data
(60) Provisional application No. 62/687,767, filed on Jun. 20, 2018.

(51) Int. Cl. G06Q 20/32; G06F 16/29; H04W 4/021; H04W 4/02

(52) U.S. Cl. CPC G06Q 20/3224; H04W 4/023; H04W 4/021; G06F 16/29

(57) ABSTRACT

Systems and methods are disclosed for location-aware event monitoring. In an embodiment, a computing platform receives an indication of an event. The location of a mobile computing device associated with the event is determined. Additional information about the event may then be retrieved based on the location of the event and the location of the mobile computing device. In some embodiments, the location of more than one mobile computing device may be determined and used to associate the event with one of the mobile computing devices. In some embodiments, the distance between the location of the mobile computing device and the location of the event is used to determine further information about the event.

### CROSS-REFERENCE TO RELATED APPLICATIONS

This application claims the benefit of U.S. Provisional Patent Application No. 62/687,767, filed Jun. 20, 2018, which is hereby incorporated by reference in its entirety.

### FIELD OF INVENTION

The present disclosure relates to location-aware event monitoring and more particularly to presence-based event attribution and a location-based fraud detection systems and methods.

### BACKGROUND

Electronic payment methods are a popular way of paying at merchants. For example, the ubiquitous credit card is a common method of paying at merchants such as restaurants and stores. However, several challenges face electronic payment users.

First, fraudulent use of electronic payment methods is a concern. For example, an unauthorized user may steal or copy a credit card and use it to pay for transactions at various merchants. Known methods of detecting fraudulent use include behavioral analysis of user's purchase habits. For example, if a user establishes a routine of transactions at a set of merchants, a large transaction at a different merchant may be an indicator of fraudulent usage. However, such behavioral approaches are ineffective at detecting fraudulent use that coincides with established behaviors. For example, a large purchase at a merchant that a user regularly frequents may not be flagged as fraudulent by known behavioral analysis fraud detection techniques.

Second, the information available about transactions is often incomplete or difficult to decipher. An example transaction description available from a credit card transaction may be, for example, “CAPITAL ONE CRCARD PMT THANK YOU 25 M AR.” Some financial services firms attempt to provide greater clarity to transaction identification by using simple heuristics such as title casing transaction description strings or parsing the transaction description string to determine more relevant information. However, these approaches cannot provide more information than was already available in the original string and may cause further errors.

Third, because some users share electronic payment methods, it may be unclear who is responsible for a transaction. For example, if two people share a single credit card, it may be uncertain which of the two people are responsible for each transaction. Some financial firms may issue different electronic payment methods to each person to provide greater clarity. For example, a credit card issuer may issue unique credit cards to each person to facilitate transaction tracking. However, this approach is imprecise because authorized users may continue to use the other's physical payment card.

### SUMMARY

Systems and methods are disclosed for location-aware event monitoring. In an embodiment, a computing platform such as a server or collection of servers receives an indication of an event from a third party. The third party may be, for example, a financial institution. The computing platform may then determine the identity of a user associated with the event such as an authorized card user for a credit card used during the event, for example. A mobile computing device associated with the user is then identified and its location around the time of the event determined.

Next, a location associated with the event is determined based on the received indication of the event and the location of the mobile computing device. A database including location information may then be searched for additional information related to the location associated with the event. The computing platform may then transmit a message to the mobile computing device with information gathered from these various sources that indicates the location of the event. In response, the mobile computing device may then display a notification presenting information about the location of the event and an indication of the event. In some embodiments, the event may be a fmancial transaction, for example.

In some embodiments, this additional location information may associate events with particular authorized users. For example, if two users are both authorized to initiate an event, the additional location information may determine which of the two users was present for the event.

In some embodiments, the computing platform may determine, based on the rich location data, that neither user was present for the event. In some examples, this may indicate that the event was unauthorized or fraudulent. For example, in an embodiment where the event is a fmancial transaction, the computing platform may determine that the financial transaction is fraudulent by comparing the locations of all known users and the transaction.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 illustrates an example computing environment in which the location-aware event monitoring systems and methods may operate in some embodiments;

FIG. 2 illustrates a method 200 for location-aware event monitoring according to an embodiment;

FIG. 3 illustrates the communications between various subsystems of a location-aware event monitoring system according to an embodiment;

FIGS. 4A-B illustrate a method 400 for presence-based event attribution according to an embodiment;

FIGS. 5A-B illustrates the communications between various subsystems of a presence-based event attribution system according to an embodiment;

FIG. 6 illustrates a method 600 for location-based fraud detection according to an embodiment;

FIG. 7 illustrates the communications between various subsystems of a location-based fraud detection system according to an embodiment; and

FIG. 8 illustrates an example graphical user interface of a transaction notification according to an embodiment.

### DETAILED DESCRIPTION

Systems and methods for location-aware event monitoring are disclosed. In some embodiments, a location-aware event monitoring system may locate a user during an event and use that location information to derive further information about the event. In an embodiment, the system receives fmancial transaction information from a financial institution and provides users highly detailed information about the transactions based on location data.

In an example, the location-aware event monitoring system may provide cleaned-up transaction names to a user as they review their transaction history, so that instead of simply identifying a transaction as “COF 12521,” the user is informed that the transaction happened at a specific coffee shop with a particular name at a particular address and can draw upon any accessible metadata for additional information about that location.

This other information about transactions provides users with greater insight into their transaction history and make it easier to recall past spending behavior. Further, the location information may be stored and associated with transactions for later review. Transactions may be searched by location or merchant name, rather than just the transaction description conveyed by a bank. In some examples, this rich location information may be used to generate expense reports. For example, all transactions within a certain geographic location may easily be determined and grouped together, making expense reporting easier. Because the transactions may be grouped not only by time, but also by location, this grouping may be done even when other transactions in a different geographic area are temporally interspersed with the desired expense report transactions.

Location-based search may also be used to easily find transactions based on location. For example, all transactions at a particular store may be easily determined. Further, a user's current location may be used to filter transactions. For example, a user may walk into a certain store and easily identify past transactions at that store. If receipt data is associated with the transaction, the user may quickly and easily find a receipt to return merchandise at the store, for example.

Some embodiments determine if a user is present or not for a transaction. In a set of embodiments, this presence information is used to associate one of a plurality of authorized users with a transaction. In another set of embodiments, a user's lack of presence is used as a signal that a transaction is likely to be fraudulent. If no authorized users are present for a transaction, the transaction may be more likely to be unauthorized.

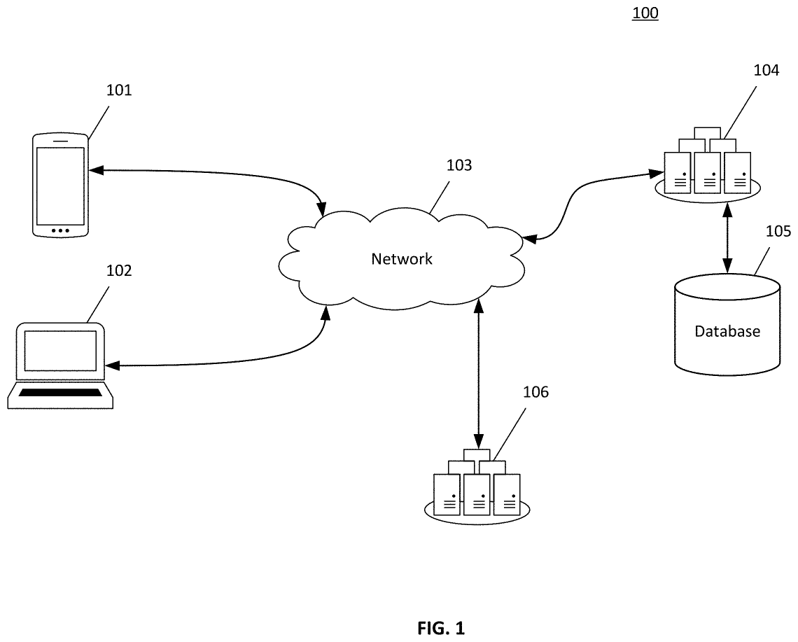

FIG. 1 illustrates an example computing environment 100 in which the disclosed location-aware event monitoring systems and methods may operate in some embodiments. Clients 101 and 102 are mobile computing devices such as may be present during an event. Two clients 101, 102 have been illustrated for simplicity, though in practice there may be more or fewer clients. For example, client 101 is illustrated as a smartphone device and client 102 is illustrated as a laptop computer. However, the clients may be any computing device present at the time of an event. For example, clients may include wearable computing devices, embedded computing devices, stationary computing devices that verify the location of a user, or any other such client devices. Clients may be implemented as several networked computer devices, though they are illustrated as a single entity.

Network 103 may include a local area network (LAN), a wide area network (WAN), a telephone network, such as the Public Switched Telephone Network (PSTN), an intranet, the Internet, or a combination of networks. Network 103 may incorporate any combination of wired or wireless communications protocols such as but not limited to cellular, Wi-Fi, ethernet, fiber optic, or other wired or wireless communications protocols.

Location-aware event monitoring computing platform 104 may be one or more computer systems of any type capable of executing operations or instructions to perform the disclosed methods. For example, computing platform 104 may be a server computer, two or more server computers in communication with each other, or a cloud computing resource executing instructions to perform portions of the methods described herein.

Database 105 may be any kind of data store capable of storing location information. Database 105 is illustrated as directly connecting to computing platform 104, but computing platform 104 and database 105 may communicate over network 103 in some embodiments. In some embodiments, database 105 may be a relational database or non-relational data store. In some embodiments, database 105 may be exposed by way of an application programming interface, or API, over network 103. In an example, database 105 may be a commercially-operated service provided by a third party and accessed via network 103.

Event data source 106 is a source of event information. For example, event data source 106 may be a financial institution which processes fmancial transactions. In another example, event data source 106 may be an identity verification system that generates event information about user authentication events. Event data source 106 may transmit event notifications in real-time to computing platform 104 via network 103. Event data source 106 may similarly transmit event data in in batches to computing platform 104 in some embodiments.

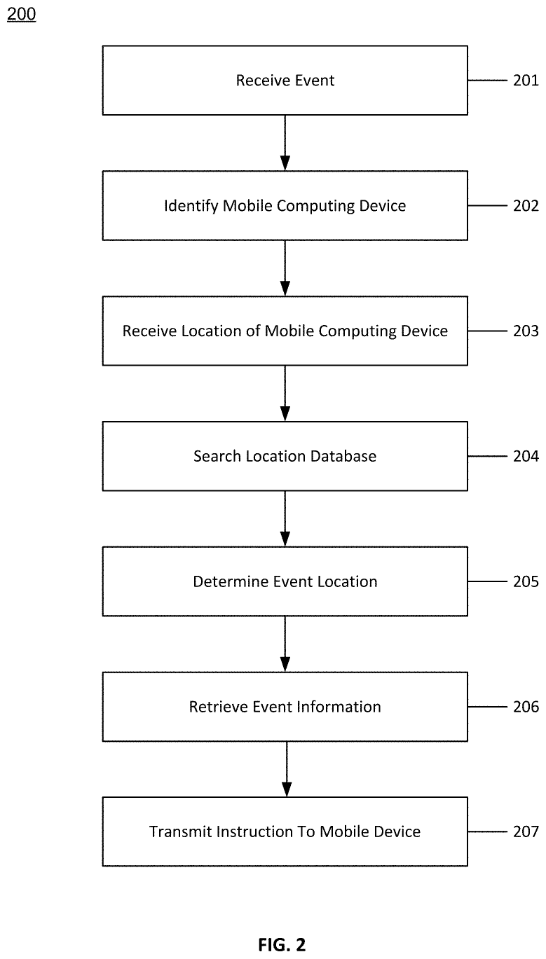

FIG. 2 illustrates a method 200 for location-aware event monitoring according to an embodiment. At step 201, a computing platform receives an indication of an event. In some embodiments, the indication of the event may be a real-time notification of a fmancial transaction from a financial institution such as a bank. For example, an indication of an event may be a real-time notification from a bank that a certain credit card transaction has been processed. The real-time notification of a fmancial transaction may include, for example, a transaction amount, a brief description, and the date and time of the transaction. The concise description received may be like what a bank records for internal own use in a monthly statement or ledger, for example.

Upon receipt of the indication of the event, the computing platform may perform some initial processing to facilitate later operations. For example, the computing platform may perform heuristics or database lookups to translate the received description of the event into a more readable format or form. The heuristics may involve, for example, changing the case of certain letters of the description, replacing abbreviations with corresponding full words, parsing location information, or some combination of these techniques. This initial ‘cleanup’ of the data may be based on observed similar events, manual modifications, or a combination of past data and manual editing.

At step 202, the computing platform identifies a mobile computing device associated with the event. As an example, the smartphone of a credit card holder may be identified if a credit card linked to their account is used in a transaction. In some embodiments, an account or individual is first identified, and then used to determine a mobile computing device associated with that account or individual. In other embodiments, the mobile computing device may be directly associated with some identifiable portion of the event indication and determined without the interstitial identification of a user or account. However, even in these embodiments, a user or account is associated with the mobile computing device and may be identified.

In some embodiments, more than one mobile computing device may be identified. For example, if two people are both authorized users of a credit card account, a mobile computing device belonging to each person may be identified.

At step 203, the computing platform receives a location of the identified mobile computing device or devices. The location of the mobile computing device may be determined through any location determination means such as GPS, global navigation satellite systems, cellular tower triangulation, a Wi-Fi® positioning system, Bluetooth® beacons, or any other such location determination. The mobile computing device may transmit its location as a geographic coordinate including a latitude and longitude, an address, a ZIP code, or any other indication of location. In some embodiments, the location may also include an altitude, a location within a building, an orientation, or any other positional information that may be relevant to locating the identified mobile computing device. In embodiments where two or more devices have been identified as associated with the event, a location is determined for each device.

In an embodiment, the computing platform may transmit a location request to the identified mobile computing device upon receiving an indication of an event. In response to receiving the location request, the mobile computing device then responds with a current location of the mobile computing device.

In an embodiment, the association between a location of the mobile computing device and an event may be determined at a later time. For example, the mobile computing device may record its location continuously, producing a timestamped location history or log. The location log may then be cross-referenced with event information at a later time to determine what the location of the mobile computing device was at or around the time of the event. This may be useful for situations where the mobile computing device is not immediately reachable for a real-time location report or for analyzing past transaction data in bulk. For example, a smartphone may record its location at regular intervals throughout the day and the computing platform may then use the location history to retroactively determine what the location of the smartphone was at various times throughout the day corresponding to events. If the location data is coarsely recorded such that an event occurs between two timestamped location records, the location of the mobile computing device may be estimated based on the available data. In an example, the timestamped location closest in time to the event may be used. In another example, the location of the mobile computing device may be interpolated or estimated based on timestamped locations close in time to the event.

In an embodiment, the time of an event may be provided as a range of times that the event may have taken place. In other words, the time of the event may be the coarsely measured information while the location of the mobile computing device may be relatively finer-grained. In such an example, there may be a plurality of locations of the mobile device that fall within the estimated time window that an event had taken place. In these embodiments, a location of the event may be compared to each of the plurality of locations of the mobile device. A match may be determined if the location of the event matches with any of the plurality of locations of the mobile device in the time window. In another example, a computed location with an error window sufficient to enclose all locations of the mobile device during the time window may be determined. For example, if the mobile device travelled from one end of a city to another during the time window of an event, the location of the mobile device used would be the centroid of its location during the time window with a radius sufficient to encompass all locations during the time window.

At step 204, the computing platform determines a location of the event. In some embodiments, the location of the event may be derived from the description received as part of an indication of the event. For example, if the description includes explicit location data, that information may be used. If the description includes information related to a location, such as an abbreviated address or the like, a location may be determined based on the received description. In some embodiments, a data source may be referenced to correlate events with locations. For example, the received event may include a textual description including a unique store identifier. The computing platform may then connect to an internal or external third-party data source such as a database or service endpoint to determine a geographic location associated with the store identifier.

In some embodiments, however, the received indication of the event may not contain sufficient information to accurately determine a location of the event. Here, the location of the mobile computing device may be leveraged to deduce a location of the event. In some embodiments, the computing platform may connect to a location database to receive a list of locations near the mobile computing device. In some embodiments, the mobile computing device may connect to a location database to receive a list of locations near the mobile computing device. For example, in an embodiment, the GOOGLE PLACES™ service may be used to determine merchants near the mobile computing device. In other embodiments, an internal data source of locations may similarly be used.

In an embodiment, a list of all potential locations within a predetermined radius of the mobile computing device is retrieved from the location database. For example, a list of all merchants within 200 feet of the location of the mobile computing device may be retrieved. In some embodiments, a list of all potential locations within a predetermined radius of the mobile computing device may be received from a remote system. Then, the description of the event is compared against the list of potential locations to determine if the event location corresponds to any of the potential locations. A stored list of past events associated with the potential locations may be used for comparison to the description of the present event to identify past events that are similar to the present event, thereby indicating that the event may have occurred at the associated location. In some embodiments, a score is calculated for each of the potential locations corresponding to a textual similarity between the name of the potential location and the description of the event received in step 201. The score may also include a distance between the potential location and the location of the mobile computing device. For example, closer potential locations may be scored higher than more distant potential locations. At step 205, a highest scoring potential location may be determined to be the location of the event. A minimum score threshold may be set so if no score is above the threshold, then no match is determined. If no match is found, a location for the transaction may be undetermined. In some embodiments, a machine learning algorithm may be used to determine the location of the event from the list of potential locations. For example, a support vector machine, a neural network, or a Bayesian network may be used to determine a location of the event from the list of potential locations. Other such machine learning models and approaches may similarly be used.

At step 206, the computing platform may retrieve additional information about the location of the event. In some embodiments, additional information may be retrieved from the location database. For example, a complete location name, address, phone number, or other such location information may be received from the event database. In some embodiments, multiple databases or services may be utilized to gather additional information about the location of the event.

At step 207, the computing platform then transmits a message or instruction to the mobile computing device. In an embodiment, the message may include information about the location of the event received from a location database, information determined from the indication of the event received in step 201, or a combination thereof. Upon receipt of the message, the mobile computing device may then display a notification including some or all of the received information. The detailed event information and associated location information may also be stored or recorded for later use by the mobile computing device, the computing platform, or both.

In an embodiment, the mobile computing device may perform additional actions based on contextual information about the location of the event. The location of the event may be categorized into a location category. Location categories may include, for example, restaurants or bars, theaters, entertainment, universities, transportation, subway, coffee shop, and so on. The mobile computing device may process the location of the event or the location category to determine additional actions to perform.

In one embodiment, the mobile computing device determines that the location of the event or the location category is a restaurant or bar or other location that accepts tips. The mobile computing device processes an amount of an associated transaction from the event and automatically pre-computes a suggested tip. The suggested tip may be based on a pre-determined percentage tip for the location of the event or the location category or may be computed using machine learning based on the user's history of tips at the location of the event or others in the location category. The mobile computing device adds the suggested tip to the financial transaction value and may include this information in the notification displayed on the mobile computing device. The notification may prompt the user to enter the tip on a purchase receipt at the merchant.

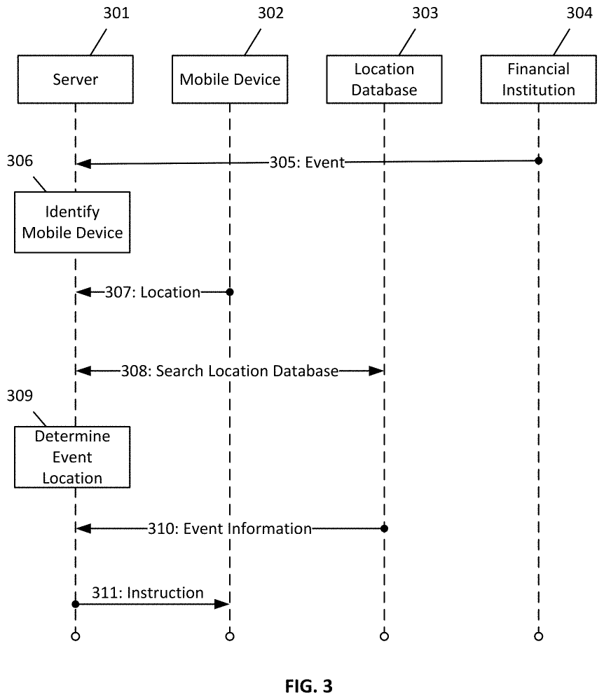

FIG. 3 illustrates the communications between various subsystems of a location-aware event monitoring system according to an embodiment. In this embodiment, server 301 may be one or more computers such as computing platform 104, mobile device 302 may be a mobile computing client device such as client 101 or 102, location database 303 may be a data store such as database 105, and fmancial institution 304 may be an event data source such as event data source 106.

At step 305, server 301 receives information about an event from financial institution 304. In an example, the event may be a fmancial transaction. At step 306, the server 301 may associate the received event with a mobile device such as mobile device 302. At step 307, server 301 receives a location from mobile device 302. As described above in the discussion of method 200, the location may be determined in real-time in response to a request from the server 301, or at a later time by analyzing location logs of the mobile computing device.

At step 308, server 301 searches location database 303 based on the indication of the event and the location of the mobile computing device. Then, at step 309 a location of the event is determined. Additional information may then be requested by the server 301 from location database 303 in step 310. Finally, at step 311, server 301 transmits an instruction including information about the location of the event and the indication of the event to mobile device 302. Upon receipt of the instruction, mobile device 302 may display a notification including at least some information contained in the instruction.

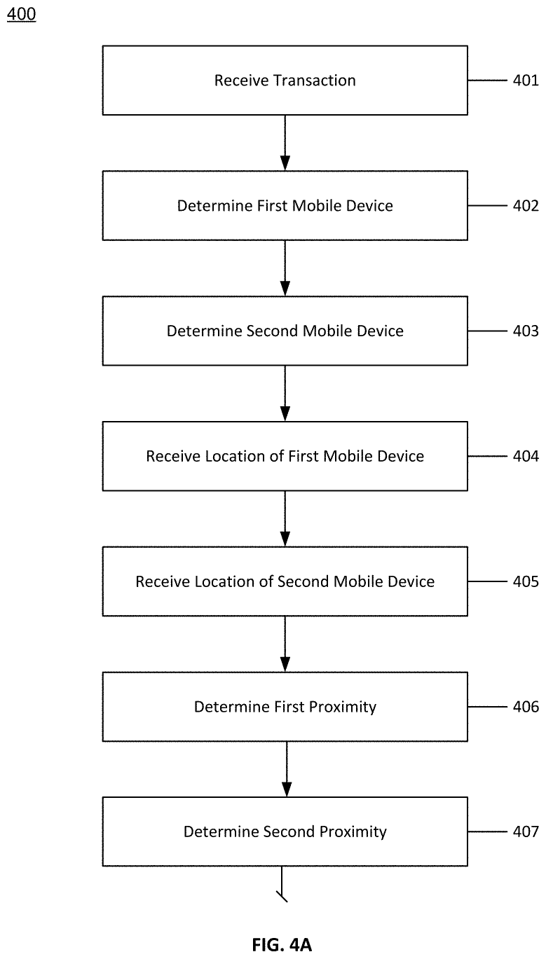

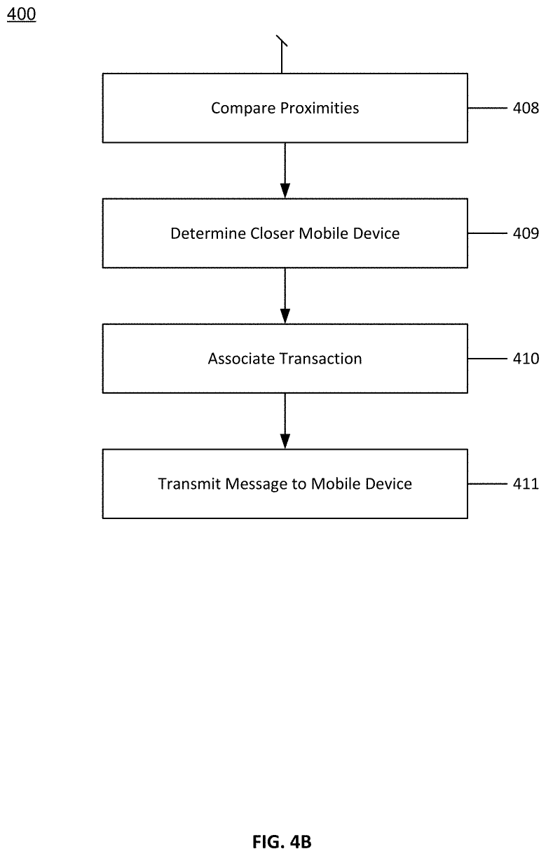

FIGS. 4A-B illustrate a method 400 for presence-based event attribution according to an embodiment. In an example, the method may assist two people who share a financial account with determining which one of them is responsible for transactions involving the shared account. This may lead to greater transparency and accountability between the co-owners of the account. FIGS. 4A-B illustrate an example with two co-owners, but the method is similarly extendable to any number of users.

Step 401 is similar to step 201 as discussed in connection with method 200. In this embodiment, however, the received event is in relation to a fmancial transaction involving a fmancial account. Step 402 and 403 are similar to step 202 of method 200 in which mobile computing devices are identified that are associated with the event, or in this case, transaction received in step 401. In an embodiment, the transaction may be associated with an account, which is associated with two authorized users, who are associated with the first and second mobile devices, respectively.

Steps 404 and 405 are similar to the location determination of step 203, but for a first mobile device in step 404 and a second mobile device in step 405. At steps 406 and 407, the proximity of the first and second mobile devices to the location of the transaction is determined. The location of the transaction may be determined by a method similar to that described in step 205 of method 200. Then, a distance or measure of proximity may be calculated between the location of the transaction and the location of each of the mobile devices. At step 408, the relative proximities of the two mobile devices are compared, and the closer device determined in step 409. For example, in step 409, it may be determined that the first mobile device is in closer proximity to the transaction than the second mobile device. The first mobile device may be then said to be present at the transaction. Then, at step 410, the transaction identified in step 401 is associated with the first mobile device and the first authorized user. This serves as an indication that the first authorized user is likely responsible for the transaction. Then, at step 411, a message is transmitted to both the first and the second mobile device, indicating the transaction and further indicating that the transaction is associated with the first authorized user.

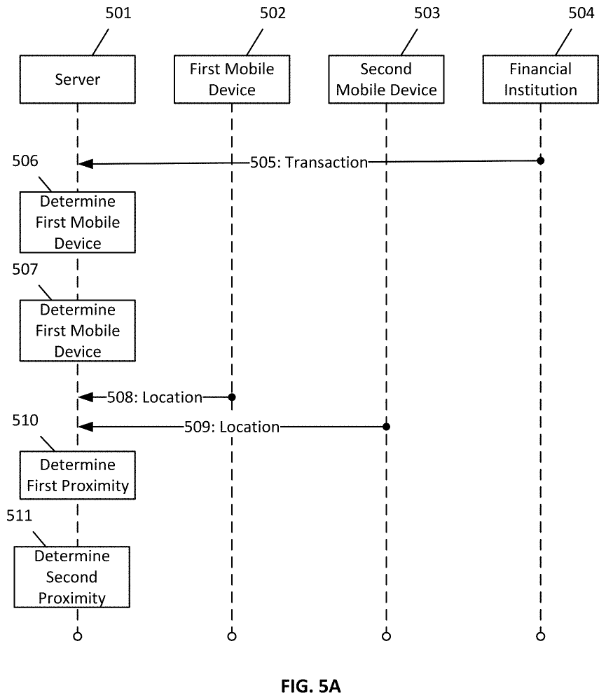

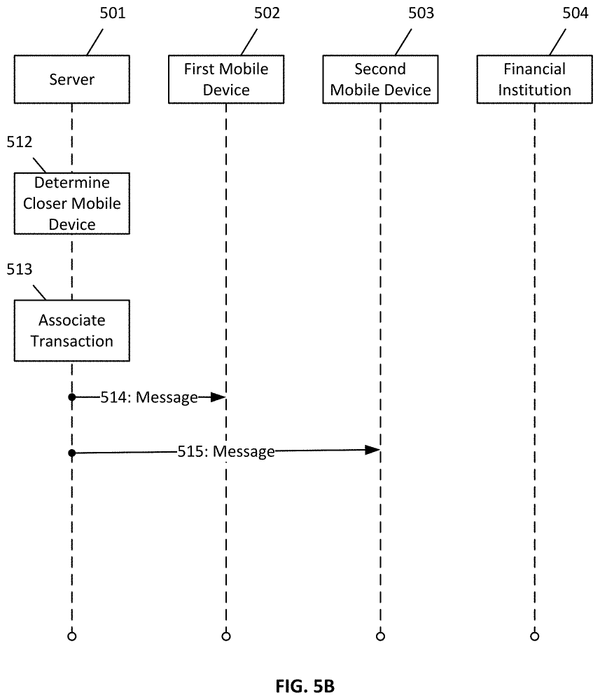

FIGS. 5A-B illustrate the communications between various subsystems of a presence-based event attribution system according to an embodiment. In this embodiment, server 501 may be one or more computers such as computing platform 104, mobile devices 502 and 503 may be mobile computing client devices such as client 101 or 102, and fmancial institution 504 may be an event data source such as event data source 106. Steps 505-515 correspond to steps 401-411 as described in connection with method 400, respectively.

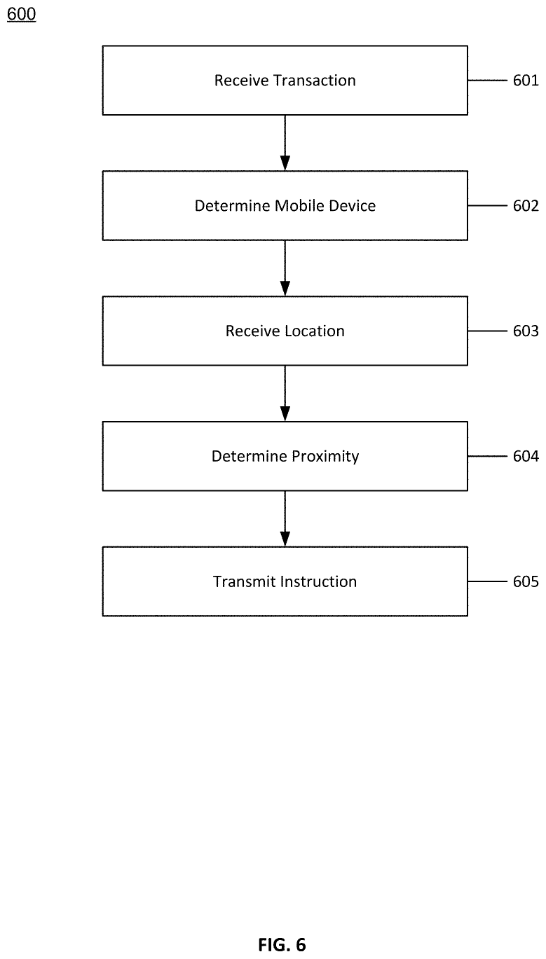

FIG. 6 illustrates a method 600 for location-based fraud detection according to an embodiment. In this embodiment, the location-aware event monitoring system may be used to determine if a transaction is likely fraudulent. This embodiment can detect fraudulent transactions that may otherwise be undetected by behavioral analysis alone. For example, if a fraudulent transaction is congruent with an authorized user's behavior, the location-aware event monitoring system may determine the transaction is nonetheless fraudulent if no authorized users were present for the transaction.

Steps 601, 602, and 603 are similar to steps 401, 402, and 404, respectively, as discussed in connection with method 400. At step 604, a proximity of the mobile device is determined in a similar way as in step 406 of method 400. But, in step 604, it is determined that the mobile computing device is not in proximity to the transaction. In an embodiment, a location for the mobile computing device and the transaction may be known, and a distance between them greater than a threshold distance. For example, when both locations are known, a mobile device may be determined to be not in proximity, or not close to, a transaction when the distance between them is greater than a quarter mile. The threshold may be set to account for variation and confidence of location determinations to minimize false positives. In implementations, the threshold may variably correspond to the accuracy and confidence of the received locations for both the mobile device and the transaction.

In an embodiment, the determination at step 604 may be as a result of no potential locations near the mobile device satisfying a minimum score threshold such as described in connection with steps 204 and 205 of method 200. That is, the location of the mobile computing device may be leveraged to deduce a location of the transaction. In this embodiment, the computing platform may connect to a location database to receive a list of locations near the mobile computing device. Next, list of all potential locations within a predetermined radius of the mobile computing device is retrieved from the location database. Then, the description of the event is compared against the list of potential locations to determine if the transaction location corresponds to any of the potential locations. In this example, a score is calculated for each of the potential locations corresponding to a textual similarity between the name of the potential location and the description of the transaction. The score calculation may also include a distance between the potential location and the location of the mobile computing device. For example, closer potential locations may be scored higher than more distant potential locations.

At step 604, in this example, no scores of any potential location is greater than a minimum score threshold. This means that no locations near the mobile device sufficiently match the transaction description. The implication is that the mobile device was not present for the transaction, an indication that the transaction was performed by someone other than an authorized user and is therefore likely fraudulent.

In an embodiment, the location of an online transaction event, for the purposes of fraud detection, may be determined to be one of a set of locations from which the user is known to conduct online transactions. For example, if a user is known to make online purchases at their home and their place of business, these locations may be the locations used for such events. An online transaction made at a location other than these known locations may be determined to be likely or possibly fraudulent. For these embodiments, a list of merchants associated with online or otherwise location-less transactions may be maintained, and the known online transaction locations used for their respective locations for a location comparison.

At step 605, an instruction or message is transmitted to the mobile device in a way similar to step 411 of method 400 or step 207 of method 200. Besides information about the location of the event received from a location database and information about the transaction, however, the instruction at step 605 includes an indication that the transaction is likely fraudulent. In some embodiments, the instruction may include further information such as the locations of any authorized users at the time of the transaction or further information on responding to the fraudulent transaction.

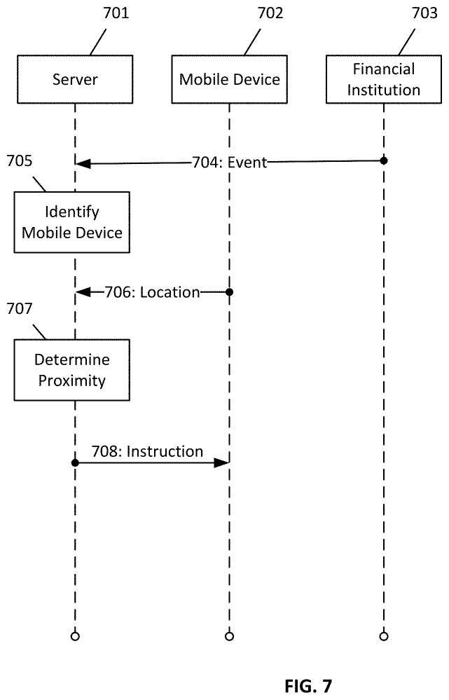

FIG. 7 illustrates the communications between various subsystems of a location-based fraud detection system according to an embodiment. In this embodiment, server 701 may be one or more computers such as computing platform 104, mobile device 702 may be a mobile computing client device such as client 101 or 102, and fmancial institution 703 may be an event data source such as event data source 106. Steps 704-708 correspond to steps 601-605 as described in connection with method 600, respectively.

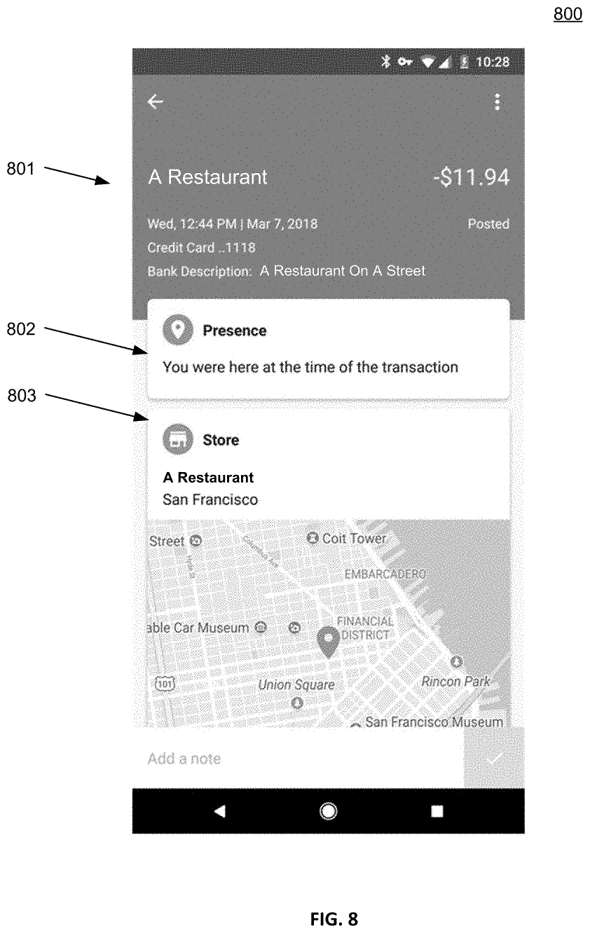

FIG. 8 illustrates an example graphical user interface 800 of a transaction notification according to an embodiment. Graphical user interface 800 may be displayed on a mobile device such as client 101 or 102, or any other such client mobile device. In an embodiment, graphical user interface 800 is displayed on a smartphone device in response to receiving an instruction or message from a server or computing platform configured to implement some or the methods described in this disclosure.

At graphical user interface element 801, an indication of a transaction is displayed. Here, the transaction indication includes the name of a merchant (“A Restaurant), a time and date of the transaction (“Wed, 12:44 PM|Mar. 7, 2018”), a value of the transaction, (“−$11.94”), a status of the transaction, (“Posted”), an identifier of the fmancial instrument involved in the transaction (“Credit Card . . . 1118”), and a reproduction of the raw transaction description string received from a third party fmancial institution (“Bank Description: A Restaurant On A Street”). The data in graphical user interface element 801 may be derived from either the transaction description received from the third party fmancial institution or from another data source such as a locations database. For example, the bank description string, amount, time and date, and indication of the fmancial instrument may be received from a third party financial institution. Likewise, the readable merchant name may be partially derived from the raw transaction description string received from a third party fmancial institution and partially derived from another data source such as a locations database.

Graphical user interface element 802 presents an indication of whether the user of the device displaying graphical user interface 800 was present during the transaction. Here, graphical user interface element 802 indicates that the user was present. In other examples of graphical user interface 800, graphical user interface element 802 may indicate that the user was not present during the transaction.

Map graphical user interface element 803 indicates a location of the transaction and may provide further identifying information about the location of the transaction. In FIG. 8, map graphical user interface element 803 shows a map pin at approximately the location of the merchant where the transaction took place. Above the map and pin is a name of the merchant (“A Restaurant San Francisco”) and a merchant category identifier (“Store”). This additional information and the map display may assist users in identifying, recognizing, and processing transactional history.

The foregoing description is merely illustrative and is not intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. One or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A method, comprising:
receiving, by a computing platform, an indication of an event, the indication of the event comprising a textual description;
identifying a mobile computing device associated with an authorized user associated with the event;
receiving, by the computing platform and from the mobile computing device, a location of the mobile computing device around the time of the event, the location of the mobile computing device comprising a latitude and a longitude;
searching a location database, based on the indication of the event and the location of the mobile computing device, for a location of the event, the searching comprising identifying points of interest within a predetermined radius of the mobile computing device in a geographic database and comparing the textual description of the event with a plurality of textual descriptions of the points of interest and calculating a plurality of similarity scores;
determining, based on the searching, a location of the event based on a highest score of the plurality of similarity scores, the highest score being above a minimum score threshold;
retrieving, from the location database, information about the location of the event; and
transmitting, from the computing platform and to the mobile computing device, an instruction including the information about the location of the event and the indication of the event.

2. The method of claim 1, wherein the receiving, by the computing platform and from the mobile computing device, a location of the mobile computing device around the time of the event comprises:
in response to receiving the indication of the event, transmitting, by the computing platform and to the mobile computing device, an instruction to transmit the location of the mobile computing device to the computing platform; and
receiving, by the computing platform and from the mobile computing device, the location of the mobile computing device.

3. The method of claim 1, wherein the receiving, by the computing platform and from the mobile computing device, a location of the mobile computing device around the time of the event comprises:
receiving, by the computing platform and from the mobile computing device, a timestamped location log for a period of time including the time of the event;
identifying a log entry of the timestamped location log that is closest in time to the time of the event; and
determining the location of the mobile computing device around the time of the event to be the location associated with the log entry.

4. The method of claim 1, further comprising:
identifying a second mobile computing device associated with a second authorized user associated with the event;
receiving, by the computing platform and from the second mobile computing device, a location of the second mobile computing device around the time of the event;
determining a first distance between the mobile computing device around the time of the event and the location of the event;
determining a second distance between the second mobile computing device around the time of the event and the location of the event;
comparing the first distance with the second distance;
based on the comparing, determining that the first distance is less than the second distance; and
associating the event with the mobile computing device and the authorized user,
wherein the instruction further includes an indication that the event is associated with the authorized user.

5. The method of claim 4, further comprising:
transmitting, from the computing platform and to the second mobile computing device, the instruction,
wherein receiving the instruction by the second mobile computing device causes the second mobile computing device to display a notification including at least some information contained in the instruction.

6. The method of claim 1, wherein the searching a location database, based on the indication of the event and the location of the mobile computing device, for a location of the event, comprises:
determining a list of potential event locations within a predetermined distance from the location of the mobile computing device, and
wherein the determining, based on the searching, a location of the event, comprises:
selecting the event location from the list of potential event locations with the greatest correspondence with the indication of the event.

7. The method of claim 6, wherein the selecting the event location from the list of potential event locations with the greatest correspondence with the indication of the event, comprises:
comparing the indication of the event with metadata related to the potential event locations; and
selecting the potential event location with the metadata that most closely matches the indication of the event.

8. The method of claim 1, further comprising:
measuring a distance between the location of the event and the location of the mobile computing device around the time of the event; and
determining that the distance is greater than a threshold distance,
wherein the instruction further includes an indication that the event likely was not authorized by the authorized user.

9. The method of claim 1, further comprising:
searching an event database for event metadata related to the indication of the event,
wherein the instruction further includes the event metadata.

10. A method, comprising:
receiving an indication of an event;
determining a first mobile device associated with a first authorized user associated with the event;
determining a second mobile device associated with a second authorized user associated with the event;
receiving a location of the first mobile device;
receiving a location of the second mobile device;
searching a location database, based on the indication of the event and the location of the first and second mobile device, for a location of the event, the searching comprising identifying points of interest within a predetermined radius of the first and second mobile computing device in a geographic database and comparing the textual description of the event with a plurality of textual descriptions of the points of interest and calculating a plurality of similarity scores;
determining, based on the searching, a location of the event based on a highest score of the plurality of similarity scores, the highest score being above a minimum score threshold;
determining a first proximity of the first mobile device to the event;
determining a second proximity of the second mobile device to the event;
comparing the first proximity with the second proximity;
determining the first mobile device is in closer proximity to the event than the second mobile device;
associating the event with the first mobile device and the first authorized user; and
determining that the event is associated with the first authorized user.

11. The method of claim 10, wherein the first authorized user and the second authorized user are both associated with the event.

12. The method of claim 10, further comprising:
prior to associating the event with the first mobile device and the first authorized user, determining the first mobile device is in closer proximity to the event than a threshold proximity.

13. The method of claim 10, wherein the indication of an event includes a location of the event.

14. The method of claim 10, wherein the determining a first proximity of the first mobile device to the event, comprises:
determining a list of potential event locations within a predetermined distance from the location of the first mobile device;
selecting a matching event location of the list of potential event locations most similar to the indication of the event; and
measuring the distance from the matching event location to the location of the first mobile device.

15. The method of claim 10, wherein receiving the message by the first mobile device causes the first mobile device to display a notification indicating the event.

16. A method for fraud detection, comprising:
receiving, by a computing platform, an indication of an event, the indication of the event comprising a textual description;
determining a mobile computing device associated with the event;
receiving a location of the mobile computing device;
searching a location database, based on the indication of the event and the location of the mobile computing device, for a location of the event, the searching comprising identifying points of interest within a predetermined radius of the mobile computing device in a geographic database and comparing the textual description of the event with a plurality of textual descriptions of the points of interest and calculating a plurality of similarity scores;
determining, based on the searching, a location of the event based on a highest score of the plurality of similarity scores, the highest score being above a minimum score threshold;
determining the mobile computing device was not in proximity to the event; and
transmitting an instruction to the mobile computing device indicating the event is likely fraudulent.

17. The method of claim 16, wherein receiving the instruction, by the mobile device, causes the mobile device to display a notification indicating the event and indicating the event is likely fraudulent.

18. The method of claim 16, wherein the determining a mobile computing device associated with the event, comprises:
determining an authorized user associated with the event; and
determining the mobile computing device is associated with the authorized user.

19. The method of claim 16, wherein the receiving a location of the mobile computing device comprises:
transmitting to the mobile computing device an instruction to transmit the location of the mobile computing device to the computing platform; and
receiving, by the computing platform and from the mobile computing device, the location of the mobile computing device.

20. The method of claim 16, wherein the indication of the event includes a location of the event, and
wherein the determining the mobile computing device was not in proximity to the event, comprises:
determining a distance between the location of the event and the location of the mobile computing device; and
determining the distance is greater than a threshold distance.
